(19) United States
(12) Patent Application Publication
(10) Pub. No.: US 2026/0194034 A1
(43) Pub. Date: Jul. 9, 2026

(54) FUEL INJECTOR

(71) Applicant: CLEAN AIR POWER GT LIMITED, Melton Mowbray, Leicestershire (GB)

(72) Inventors: Dan SKELTON, Melton Mowbray, Leicestershire (GB); Ed NEWMAN, Melton Mowbray, Leicestershire (GB); Neil SULLY, Bispham, Lancashire (GB)

(21) Appl. No.: 19/130,430

(22) PCT Filed: Nov. 20, 2023
(86) PCT No.: PCT/GB2023/053033

§ 371 Date: May 15, 2025

(30) Foreign Application Priority Data
Nov. 18, 2022 (GB) 2217334.8

(51) Int. Cl. F02M 61/04; F02M 61/18; F02M 63/00

(52) U.S. Cl. CPC F02M 61/04; F02M 61/1886; F02M 63/0017

(57) ABSTRACT

The present disclosure relates to a modular fuel injector (100). In particular, the disclosure relates to a “top in bottom out” fuel injector (100) comprising a housing (102) having a fluid inlet (202) at a first, upstream, longitudinal end of the housing (102) and a fluid outlet (108) at a second, downstream, longitudinal end of the housing (102). The injector (100) comprises a plunger (222), and in an open configuration, permits fluid flow from the fluid inlet (202) to the fluid outlet (108) along a flow path comprising a flow path section extending along a longitudinal axis of the housing (102). A fuel injection system is also disclosed. (FIG. 1)

### CROSS-REFERENCE TO RELATED APPLICATIONS

This application is a national stage entry under 35 U.S.C. § 371(b) of PCT International Application No. PCT/GB2023/053033, filed Nov. 20, 2023, which claims the benefit of United Kingdom Patent Application Serial No. 2217334.8, filed Nov. 18, 2022, the entire disclosures of both of which are incorporated herein by reference.

### TECHNICAL FIELD

The present disclosure relates to a fuel injector. In particular, the disclosure relates to a “top in bottom out” fuel injector comprising a housing having a fluid inlet at a first, upstream, longitudinal end of the housing and a fluid outlet at a second, downstream, longitudinal end of the housing. A fuel injection system is also disclosed.

### BACKGROUND

Greenhouse gas emissions from internal combustion engines (ICEs) contribute to anthropogenic climate change. To reduce greenhouse gas emissions related to ICEs, fossil fuels will likely be replaced by alternative fuels.

Such alternative fuels may include biomethane, hydrogen, and ammonia. However, these alternative fuels are more complicated to use than fossil fuels. In particular, in the prior art, gas injectors have been provided for port injection. However, there are numerous problems with only using port injection, including back fire risk and limited controllability.

Injectors capable of carrying more complicated alternative fuels such as biomethane, hydrogen and ammonia are required as an enabler to allow a move to low carbon fuelled ICEs. Such ICEs are expected to take a significant proportion of the diesel, gasoline and natural gas ICE market and will be applicable to automotive, marine, construction, off-highway, mining and generator markets. However, during the transition to alternative fuels, there is also still a need for improved injectors for diesel and gasoline ICEs.

Top in bottom out injectors in which a fluid flows into the injector at a first end, and exits the injector at a second end opposite the first end, are favoured in both ICEs and in engines using alternative fuels. However, they require close fitting sliding surfaces which increase manufacturing complexity and costs.

The inventors have appreciated the need for a “top in bottom out” fuel injector which may be produced more easily and with less close fitting sliding surfaces.

### SUMMARY OF THE DISCLOSURE

The present disclosure includes one or more of the features recited in the appended claims and/or the following features which, alone or in any combination, may comprise patentable subject matter.

The present disclosure provides a fuel injector and a fuel injection system, as defined in the appended claims, to which reference should now be made.

According to a first aspect of the present disclosure, there is provided a fuel injector comprising a housing. The housing comprises: a fluid inlet at a first, upstream, longitudinal end of the housing; a fluid outlet at a second, downstream, longitudinal end of the housing; a valve opening disposed between the fluid inlet and the fluid outlet; and a valve seat surrounding the valve opening. The injector further comprises: a ball valve element disposed within the housing; a resilient element arranged to bias the ball valve element towards the valve seat to close the valve opening; and a plunger configured to displace the ball valve element. The fuel injector is configurable between a closed configuration, in which the ball valve element is held in the valve seat by the resilient element, and an open configuration, in which the plunger displaces the ball valve element away from the valve seat to permit fluid flow from the fluid inlet to the fluid outlet along a flow path comprising a flow path section extending along a longitudinal axis of the housing.

By providing a resilient element and a ball valve element, and a plunger configured to push the ball valve element off a valve seat upon actuation, and by providing a flow path extending along a longitudinal axis of the fuel injector, the fuel injector of the present disclosure may allow for a “top in bottom out” type injector to be provided without requiring close fitting sliding surfaces. Thus, the fuel injector of the present disclosure may be produced with reduced complexity and costs, as greater tolerances/clearances are acceptable.

The fuel injector of the present disclosure may require no lubricant, i.e. the injector may be configured to be lubricant-free. Because the ball valve element is guided by the resilient element, greater tolerances/clearances are acceptable, and lubrication is not required (e.g. compared to a system in which a plunger is used to control and guide a ball valve element).

The greater tolerances/clearances may also allow the injector of the present disclosure to work in a wider range of temperatures than prior art injectors.

Due to the greater clearances, the injector of the present disclosure may be suitable for use at and above about minus 30 degrees Celsius, or for use at and above about minus 50 degrees Celsius. In other words, the injector may be suitable for use with cryogenic fuels, cold refrigerant type fuels, and other harsh fuels (e.g. dimethyl ether (DME)).

As used herein, the term “longitudinal axis” relates to a central axis from one longitudinal end of a body to the other longitudinal end. In other words, the longitudinal axis is the axis of a body from one end to the other end of the body which includes a central point of the body. For example, the longitudinal axis of the housing is a central axis from the upstream end of the housing to the downstream end of the housing.

Optionally, the resilient element is a spring. Springs may be inexpensive and are readily available with a variety of properties. Alternatively, the resilient element may be a resilient material, such as rubber. For example, the resilient element may be a tube of rubber.

Optionally, the flow path section may extend within the plunger. This may allow for flow to be channelled through a central portion, i.e. along a longitudinal axis, of the housing/fuel injector.

Optionally, the plunger and the housing are arranged coaxially. In other words, a longitudinal axis of the plunger may be substantially aligned with a longitudinal axis of the housing. Such an arrangement may allow for the plunger to easily move within the housing, and for the flow path section to extend within the plunger, and along a longitudinal axis of the housing.

The plunger may comprise a fluid flow channel, the flow path section extending at least through the fluid flow channel. This may allow for fluid flow through the plunger and along a central longitudinal axis of the injector/housing. Indeed, it may also allow for the injector to be lighter.

Further optionally, the fluid flow channel of the plunger terminates at a downstream opening. This may allow for flow to easily exit the plunger. It may also facilitate manufacturing of the hollow plunger.

The downstream opening may be arranged at or near a downstream end of the plunger.

A flow path section extending within the plunger, and/or the plunger comprising a fluid flow channel, and in particular a fluid flow channel which terminates at a downstream opening at or near a downstream end of the plunger, may allow for the fuel injector to be suitable for a wider range of fuels. For example, the fuel injector of the present disclosure may be suitable for use with gaseous ammonia and liquid ammonia.

Use of the injector with a wider range of fuels may be facilitated by the fuel injector being configured so that any component of the injector which may be susceptible to wear, such as an electrically conducive coil for moving the plunger, does not come into contact with the fuel.

The fuel injector may also be suitable for use with other cryogenic fuels, cold refrigerant type fuels, and other harsh fuels, such as dimethyl ether (DME).

The plunger may comprise at least one upstream opening to permit fluid flow between a, or the, fluid flow channel of the plunger and the valve opening. Such an upstream opening may allow fluid to easily flow between the fluid inlet and the fluid outlet via the interior of the plunger when the injector is in the open configuration.

Optionally the plunger may comprise two or more upstream openings. Providing two or more upstream openings may allow for increased fluid flow.

Further optionally, the two or more upstream openings are arranged annularly around the longitudinal axis of the plunger. Annularly arranged upstream openings may allow for an even fluid flow.

Yet further optionally, the two or more upstream openings are annularly spaced substantially evenly about a circumference of the plunger. Evenly spacing the annular upstream openings may further improve uniformity of fluid flow.

Optionally, an upstream end of the plunger is configured to directly displace the ball valve element. Directly displacing the ball valve may allow for improved control over reconfiguration between open and closed configuration.

Optionally, the plunger comprises an integral drive pin aligned with the valve opening.

Alternatively, an upstream end of the plunger is configured to indirectly displace the ball valve element. For example, a further element coupled to the upstream end of the plunger may act to displace the ball valve element, or a further element may be provided which the upstream end of the plunger engages to displace the ball valve element.

Optionally, a drive pin is coupled to the plunger and aligned with the valve opening. Alternatively, the plunger is configured to act on a drive pin, the drive pin being aligned with the valve opening.

Optionally, the drive pin may be solid. A solid drive pin may prevent any backflow of fluid from the hollow plunger into the drive pin. It may also improve reliability.

Optionally, in the open configuration, at least a portion of the drive pin extends through the valve opening to push the ball valve element away from the valve seat. This may allow for the ball valve element to be reliably and repeatedly displaced away from the valve seat. Indeed, it may also allow for large manufacturing tolerances.

Optionally, the fuel injector further comprises a guide arranged to surround an upstream portion of the plunger, or the drive pin. The guide is for aligning the drive pin, or upstream portion of the plunger, with the valve opening, so that the drive pin or upstream portion of the plunger may reliably extend through the valve opening to push the ball valve element away from the valve seat.

Optionally, the guide comprises at least one guide opening for permitting fluid to flow through the guide. Further optionally, the or each guide opening is configured to permit fluid flow through the guide along an axis that is parallel to the longitudinal axis. This may allow for improved and more uniform fluid flow.

Optionally, the resilient element, ball valve element, valve seat, and valve opening are arranged adjacent the fluid inlet. This may allow for fluid to be intermittently allowed to flow into the injector at the upstream end.

The fuel injector may comprise a passive valve for preventing upstream fluid flow from the fluid outlet towards the fluid inlet. The passive valve may prevent any upstream flow through the housing. For example, any build-up of pressure during the combustion phase is prevented from affecting the injector. Thus, the injector may directly inject into a cylinder, but still be protected from any combustion pressures.

The passive valve may comprise a movable valve component, wherein the passive valve is arranged such that: movement of the movable valve component in a downstream direction opens the passive valve and/or the movable valve component is biased in an upstream direction to bias the passive valve into a closed configuration. This may allow for the fuel injector to be used when a fuel pressure in a feed is lower than a pressure in the cylinder, because the higher pressure in the cylinder acts to close, or keep closed, the passive valve.

The passive valve may be a pressure-operated control valve. Such a pressure-operated control valve may prevent upstream fluid flow while allowing downstream fluid flow if a downstream fluid pressure exceeds a pressure threshold.

Optionally, the passive valve may be a passive ball valve. Further optionally, the passive ball valve comprises a second resilient element, a second ball valve element, and a second valve seat, wherein the second resilient element is arranged to bias the second ball valve element towards the second valve seat to close the second valve opening. Thus, the non-return valve is normally closed. Such a passive ball valve may allow for relatively large manufacturing tolerances, especially when compared to needle type valves. Further, a passive ball valve is reliable and therefore may require less maintenance.

Because the second resilient element is configured to guide the second ball valve element back into the second valve seat to close the second valve opening by the second resilient element, greater tolerances/clearances are acceptable, and lubrication is not required.

Optionally, the second resilient element is arranged to bias the second ball valve element towards the second valve seat in an upstream direction to close the second valve opening. This may allow for the fuel injector to be used when a fuel pressure in a feed is lower than a pressure in the cylinder, because the higher pressure in the cylinder acts to close, or keep closed, the passive valve.

The second ball valve element may be the movable valve component.

The passive valve may be a non-return valve.

The second resilient element may be configured so that a biasing force exerted by the second resilient element on the second ball valve element is such that fluid flow from the fluid inlet to the fluid outlet pushes the second ball valve element off the second valve seat, thus opening the second valve opening.

Optionally, the second resilient element may be a spring.

The passive valve may be arranged adjacent the fluid outlet. This arrangement may prevent combustion pressures from affecting any portion of the injector.

Optionally, the fluid inlet comprises at least one inlet opening in the first, upstream, longitudinal end of the housing. This may allow fluid flow into an upstream longitudinal end surface of the housing.

Further optionally, the fluid inlet comprises a plurality of inlet openings in the first, upstream, longitudinal end of the housing. A plurality of inlet openings may allow for increased fluid flow.

Optionally, the plurality of inlet openings is arranged in the first, upstream, longitudinal end of the housing annularly around the longitudinal axis of the housing. Such an arrangement may allow for more even fluid flow.

Optionally, the plurality of inlet openings is annularly spaced in the first, upstream, longitudinal end of the housing, substantially evenly around the longitudinal axis of the housing. This may allow for uniform fluid flow.

The or each inlet opening may be configured to permit fluid flow through the first, upstream, longitudinal end of the housing along an axis that is parallel to the longitudinal axis. This may allow for controlled flow of fluid into the injector housing.

Optionally, the fluid outlet comprises at least one outlet opening in the second, downstream, longitudinal end of the housing. This may allow fluid flow out of a downstream longitudinal end surface of the housing.

Further optionally, the fluid outlet comprises a plurality of outlet openings in the second, downstream, longitudinal end of the housing. A plurality of outlet openings may allow for increased fluid flow out of the injector.

Optionally, the plurality of outlet openings is arranged in the second, downstream, longitudinal end of the housing annularly around the longitudinal axis of the housing. Such an arrangement may allow for more even fluid flow.

Optionally, the plurality of outlet openings is annularly spaced in the second, downstream, longitudinal end of the housing, substantially evenly around the longitudinal axis of the housing. This may allow for uniform fluid flow.

The or each outlet opening may be configured to permit fluid flow through the second, downstream, longitudinal end of the housing along an axis that is parallel to the longitudinal axis. This may allow for controlled flow of fluid out of the injector housing.

Optionally, the fuel injector further comprises: a coil; a first magnetic element arranged to surround at least a portion of the plunger; and a second magnetic element forming at least part of the plunger, such that energisation of the coil energises the first magnetic element and causes the plunger to move, actuating the fuel injector from the closed configuration to the open configuration. Such an arrangement allows for displacement of the plunger to be controlled reliably and precisely.

Optionally, the injector is configured so that the fluid flow path avoids the coil. In other words, the injector is configured so that fuel does not come into contact with the coil. By avoiding contact of the fuel with the coil, longevity of the injector may be improved, and the injector may be capable of using a wider variety of fuels, including cryogenic fuels such as ammonia, and “dry” gases such as hydrogen.

In other words, the injector may be configured so that the coil sits outside the fuel flow path of the injector.

Optionally, the housing, towards the second, downstream, longitudinal end, may comprise a coupling configured to engage an outlet insert comprising a fuel injector tip. Such a coupling may allow for different outlet inserts having different fuel injector tips for specific applications and spray patterns to be coupled to the injector.

Optionally, the coupling comprises a thread configured to engage a corresponding thread of the outlet insert. A thread is a simple type of a coupling that may maintain secure engagement between the injector and the outlet insert.

Optionally the fuel injector comprises a, or the, outlet insert comprising a, or the, injector tip. As used herein, the term “upstream” refers to portions of the injector which are toward, along a fuel/fluid flow path, a fluid inlet of the injector. Similarly, the term “downstream” refers to portions of the injector which are toward, along a fuel/fluid flow patch, a fluid outlet of the injector.

It is noted that while an “upstream end” or “fluid inlet” and a “downstream end” and “fluid outlet” of the injector are referred to herein, if the fuel injector comprises a, or the, outlet insert, the injector comprises elements downstream of its “downstream end” or “fluid outlet”. However, in this case, the term “downstream end” or “fluid outlet” of the injector refers merely to the “downstream end” or “fluid outlet” of the injector proper, or core of the injector, without the outlet insert.

Optionally, the outlet insert may comprise an outlet insert passive valve for preventing upstream fluid flow from the injector tip towards the fluid outlet.

The outlet insert passive valve may be an outlet insert pressure-operated control valve, or an outlet insert non-return valve. A pressure-operated control valve may prevent upstream fluid flow while allowing downstream fluid flow if a downstream fluid pressure exceeds a pressure threshold.

A removable housing portion may be coupled reversibly to a remainder of the housing. Having a portion of the housing, i.e. the removable housing portion, which is coupled reversibly to a remainder of the housing allows for increased versatility of the injector, thus allowing for the injector to be usable in a broader range of applications.

Optionally, the remainder of the housing comprises a housing coupling configured to engage with a corresponding housing coupling of the removable housing portion. Such a housing coupling may allow for easy coupling and decoupling of the removable housing portion and the remainder of the housing.

Further optionally, the housing coupling comprises at least one of: a thread; a connecting portion configured to engage with the removable housing portion in a swaged manner; and a ferrule. A thread is a simple type of coupling that can maintain secure engagement between the injector and the outlet insert. Further, a connecting portion configured to engage with the housing portion in a swaged manner, and a ferrule, may allow for a secure yet releasable connection between the removable housing portion and the remainder of the housing.

The removable housing portion may comprise the valve seat, the valve opening, the ball valve element, and the resilient element. By providing the valve seat, valve opening, ball valve element, and resilient element as part of the removable housing portion, appropriate selections of these elements may be made for each application. In particular, the size of the valve opening and ball valve element, and properties of the resilient element, may be adjusted to control the rate and amount of fluid flow per displacement of the ball valve element.

A majority of the flow path may extend along the longitudinal axis of the housing. Optionally, at least 60%, or at least 65%, or at least 70%, or at least 75% of the flow path may extend along the longitudinal axis of the housing.

According to a second aspect of the present disclosure, there is provided a fuel injection system comprising: a source of pressurised fuel, and a fuel injector according to any preceding claim, the source of fuel being connected to the fluid inlet. Such a fuel injection system may be suitable for injection of a variety of different fuels.

Optionally, the source of pressurised fuel is a source of hydrogen, a source of ammonia, a source of natural gas, a source of diesel, or a source of gasoline.

The fuel injector of the first aspect, and the fuel injection system of the second aspect, may be suitable for direct injection of fuel. That is, they may be suitable for, or configured to, directly inject fuel into an engine.

It will be appreciated that features described in relation to one aspect of the present disclosure may also be applied equally to all of the other aspects of the present disclosure. Features described in relation to the first aspect of the present disclosure may be applied equally to the second aspect of the present disclosure and vice versa. Additional features, which alone or in combination with any other feature(s), such as those listed above and/or those listed in the claims, can comprise patentable subject matter and will become apparent to those skilled in the art upon consideration of the following detailed description of various embodiments exemplifying the best mode of carrying out the embodiments as presently perceived.

### BRIEF DESCRIPTION OF DRAWINGS

The disclosure will be further described, by way of example only, with reference to the accompanying drawings, in which:

FIG. 1 shows a side view of an example fuel injector;

FIG. 2 shows a cross-sectional perspective view of the example fuel injector of FIG. 1;

FIG. 3 shows a top view of the example fuel injector of FIGS. 1 and 2;

FIG. 4a shows a cross-sectional side view of the example fuel injector of FIGS. 1, 2, and 3 in a closed configuration;

FIG. 4b shows a cross-sectional side view of the example fuel injector of FIGS. 1 to 4a in an open configuration;

FIG. 5a shows a partial cross-sectional bottom view along axis Y-Y′ of the example fuel injector of FIGS. 1 to 4b; and

FIG. 5b shows a cross-sectional bottom view along axis X-X′ of the example fuel injector of FIGS. 1 to 5a.

### DETAILED DESCRIPTION OF DRAWINGS

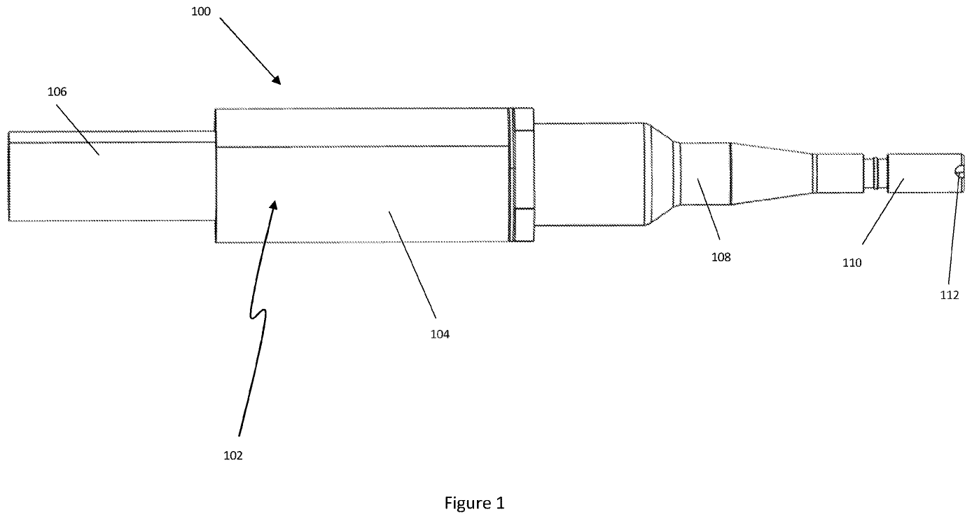

FIG. 1 shows a side view of a fuel injector 100, comprising a housing 102, which is made up of a first housing portion 104, which forms a permanent portion, or core, of the fuel injector 100, and a second, removable housing portion 106, coupled upstream to the first housing portion 104.

Downstream of the housing 102 and coupled to the first housing portion 104 is an outlet insert 108 having a fuel injector tip 110. The fuel injector tip 110 has an opening 112 shaped to provide a desired spray pattern.

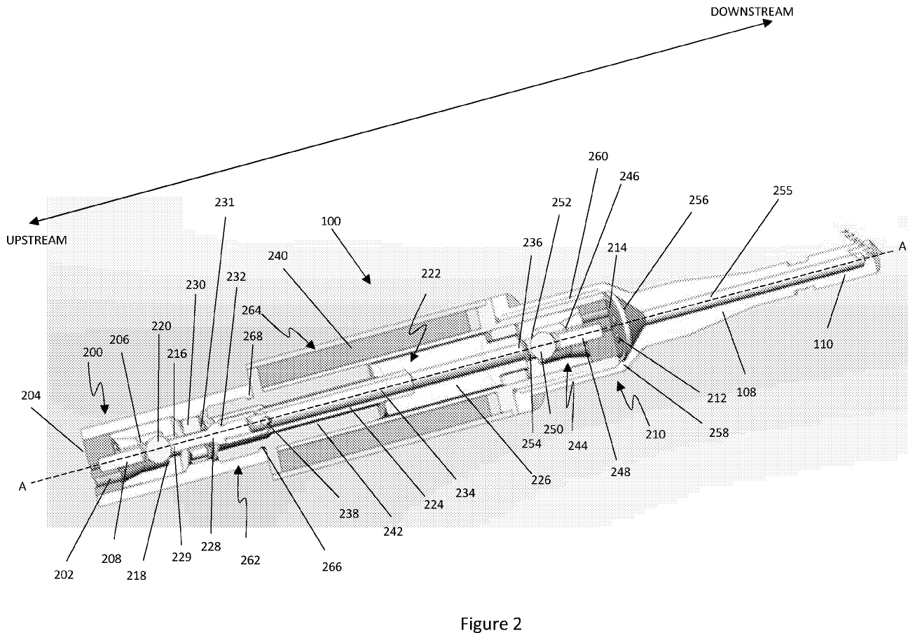

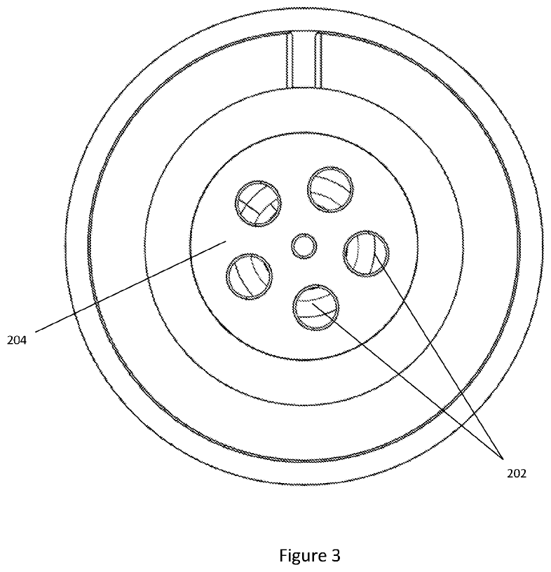

As shown in FIG. 2, at an upstream, longitudinal, end 200, the fuel injector 100 comprises five openings 202 (best seen in FIG. 3) in an upstream end surface 204, which act as a fluid inlet. The fluid inlet allows fluid to flow into the housing 102 of the injector 100.

Adjacent the fluid inlet, within the housing 102, the fuel injector 100 comprises a spring 206 arranged around a pin 208. Between the fluid inlet at the upstream end 200 of the injector 100, and a fluid outlet at a downstream end 210 of the injector 100 which comprises five openings 212 in a downstream end surface 214 of the injector 100, the housing 102 comprises a valve opening 216 and, around an upstream end of the valve opening 216, a valve seat 218.

Arranged within the housing 102 and between the valve seat 218 and the spring 206 is a ball valve element 220. The spring 206 is configured to bias the ball valve element 220 towards the valve seat 218, to hold the ball valve element 220 in the valve seat 218 to close the valve opening 216.

The injector 100 further comprises a plunger 222. The plunger 222 has a hollow cylindrical portion 224 and a downstream end portion 226 formed of a highly magnetic material. At an upstream end, the plunger 222 comprises a drive pin 228, which is provided press-fit into an upstream end of the plunger 222. The drive pin 228, at an upstream end, has a narrowed portion 229 arranged to extend through the valve opening 216. The drive pin 228 is held in the plunger 222 by a broadened connecting region 232.

Surrounding the narrowed portion 229 of the drive pin 228 is a guide 230 which ensures alignment between the drive pin 228 and the valve opening 216. The guide 230 comprises five guide openings 231 which permit fluid flow from the valve opening 216 in a downstream direction.

A central cavity 234 of the plunger 222 within the cylindrical portion 224 and the downstream end portion 226 extends along a (central) longitudinal axis A of the injector 100. As can be clearly seen from FIG. 2, the injector 100, housing 102, and plunger 222 are all arranged coaxially around the longitudinal axis A. In other words, the longitudinal axis A of the injector 100, housing 102, and plunger 222 are the same.

The central cavity 234 terminates in a downstream opening 236. At an upstream end, the cylindrical portion 224 comprises openings 238 in the wall of the hollow cylindrical portion 224, allowing fluid flow between the central cavity 234 and the upstream end 200 of the housing 102.

Surrounding the plunger 222, the injector 100 further comprises an electrically conductive coil 240, and, attached to the electrically conductive coil 240, a magnetic portion 242, surrounding portions of the cylindrical portion 224 and the drive pin 228. Upon energisation, the electrically conductive coil 240 and magnetic portion 242 cause the plunger 222 to move in an upstream direction.

Between the downstream end 210 of the injector 100 and the downstream opening 236 of the central cavity 234 of the plunger 222, and adjacent the fluid outlet, the injector 100 comprises a passive valve 244, configured to prevent upstream fluid flow from the fluid outlet towards the central cavity 234 of the plunger 222. The passive valve 244 is a pressure-operated control valve 244 that permits downstream fluid flow if a downstream fluid pressure exceeds a threshold, but prevents upstream fluid flow.

The pressure-operated control valve 244 is a ball valve comprising a second spring 246 arranged around a second pin 248. The second spring 246 is configured to bias a second ball valve element 250 towards a second valve seat 252 surrounding a second valve opening 254 between the downstream opening 236 of the central cavity 234 and a downstream end 210 of the injector 100.

The second spring 246, second valve seat 252 and second ball valve element 250 are arranged such that downstream fluid flow may displace the second ball valve element 250 from the second valve seat 252, but the second spring 246 biases the second ball valve element 250 back onto the second valve seat 252 when there is no downstream fluid flow.

The second ball valve element 250 is not constricted, i.e. it is not (fixedly) coupled to any component of the injector. The second ball valve element 250 is maintained in position by the second spring 246, and guided back onto the second valve seat 252 by the biasing force exerted by the second spring 246.

Upstream fluid flow is prevented as any upstream pressure gradient, e.g. due to combustion pressures entering the injector 100, biases the second ball valve element 250 (along with the biasing force of the second spring 246) towards the second valve seat 252, i.e. in an upstream direction, closing the pressure-operated control valve 244.

The outlet insert 108 having the fuel injector tip 110 is arranged adjacent the downstream end 210 of the fuel injector 100. A central, cylindrical cavity 255 is formed in the hollow outlet insert 108, and is connected to the five openings 212 of the fluid outlet at the downstream end 210 of the injector 100 via a funnel 256.

A portion 258 of the outlet insert 108 extends in an upstream direction over the downstream end 210 of the fuel injector 100. Said portion 258 is screwed onto the housing by means of a pair of threads 260 on the inside of the portion 258 and the outside of the downstream end 210 of the injector 100.

The housing 102 comprises a removable, upstream, portion 262 and a core 264 formed of the remainder of the housing 102. The removable portion 262 and the core 264 are coupled by engagement of an annular grove in the core 264 and a corresponding annular projection 268 of the removable portion.

As shown in FIG. 3, the five inlet openings 202 are annularly distributed about the longitudinal axis A of the injector 100. The five inlet openings 202 are evenly distributed/spaced about the longitudinal axis A, meaning that each of the five inlet openings 202 is equidistant from the longitudinal axis A, and from one another.

Also apparent from FIG. 3 is that each inlet opening 202 extends through the upstream end surface 204 in a longitudinal direction. In other words, each opening 202 extends along an axis which is parallel to the longitudinal axis A, and perpendicular to the plane of the page.

As best seen in FIG. 2, the five outlet openings 212 are also annularly distributed about the longitudinal axis A of the injector 100, evenly distributed about the longitudinal axis A, and extending through the downstream end surface 214 in a longitudinal direction.

Similarly, as best appreciated from FIG. 2, the five guide openings 231 are also annularly distributed about the longitudinal axis A of the injector 100, evenly distributed about the longitudinal axis A, and extending through the guide 230 in a longitudinal direction.

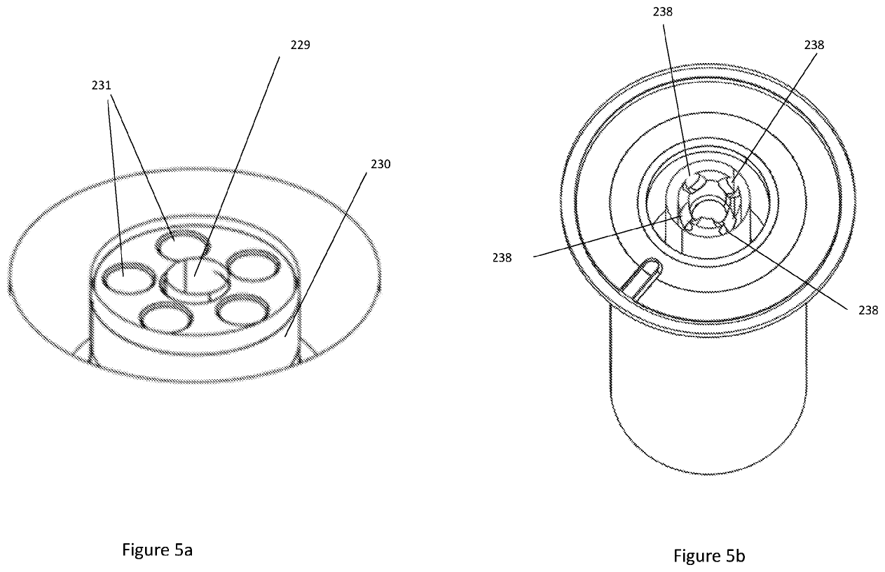

The upstream end of the cylindrical portion 224 comprises four upstream openings 238 in the cylinder wall, as best appreciated from FIG. 5b. The four upstream openings 238 are annularly distributed evenly about a circumference of the cylindrical portion 224.

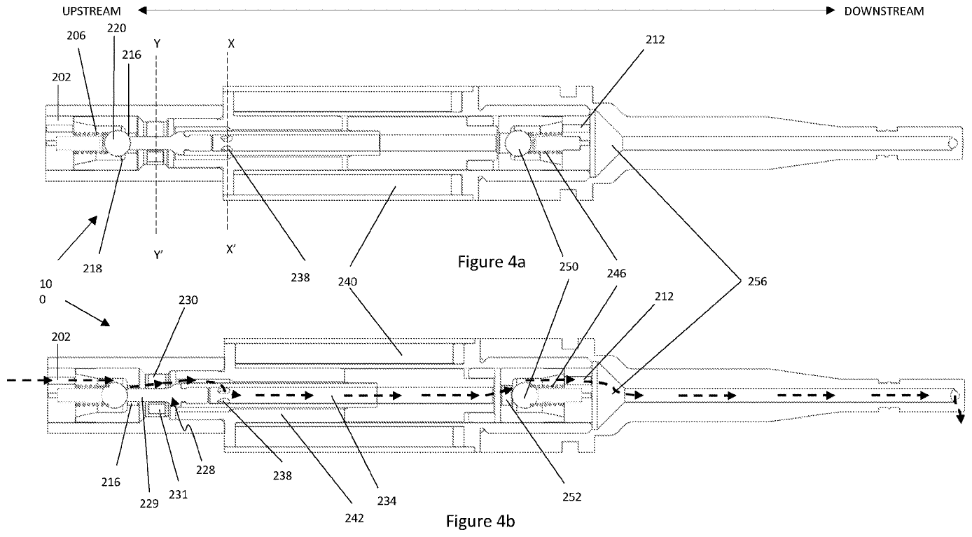

FIG. 4a shows the injector 100 in the closed configuration, or default configuration. In the closed configuration, the spring 206 biases the ball valve element 220 towards the valve seat 218, thus closing the valve opening 216. This prevents fluid from flowing through the valve opening 216. At the same time, the second spring 246 of the pressure-operated control valve 244 biases the second ball valve element 250 towards the second valve seat 252 to close the second valve opening 254. This prevents fluid from flowing through the second valve opening 254.

FIG. 4b shows the injector 100 in the open configuration, or actuated configuration. In the open configuration, a portion of the narrowed portion 229 of the drive pin 228 extends through the valve opening 216, moving the ball valve element 220 off the valve seat 218.

A fluid flow path, indicated in FIG. 4b by the arrows, leads from the inlet opening 202 (only one shown in FIGS. 4a and 4b), past the ball valve element 220 and the valve seat 218, and through the valve opening 216. The fluid flow path continues through the guide openings 231 (only one shown in FIG. 4b) and into the magnetic portion 242 and, through the upstream openings 238, into the central cavity 234 within the plunger 222, avoiding contact of the fluid flow path, and thus any fuel, with the coil 240.

From the central cavity 234, the fluid flow path leads out of the downstream opening 236 of the central cavity 234, and through the second valve opening 254 (which is opened by fluid flow pushing the second ball valve element 250 off the second valve seat 252, against the biasing force of the second spring 246). From the second valve opening 254, the fluid flow path extends, via the five outlet openings 212 (only one shown in FIG. 4b), into and through the funnel 256 and into the cylindrical cavity 255 of the outlet insert 108, and out of the opening 112 (not shown in FIG. 4b) of the fuel injector tip 110.

In use, a fluid, such as hydrogen, may flow through the openings 202 in the upstream end surface 204 of the injector 100. In a default configuration, the valve opening 216 is closed by the ball valve element 220 being biased against the valve seat 218 by the compression spring 206. This prevents the fluid from flowing through the valve opening 216.

Upon energisation of the electrically conductive coil 240, the magnetic portion 242 is energised and attracts the highly-magnetic downstream end portion 226 of the plunger 222. This movement of the plunger 222 in an upstream direction causes movement of the drive pin 228, pushing the narrowed portion 229 of the drive pin 228 through the valve opening 216 so that a portion of the narrowed portion 229 extends through the valve opening 216.

This movement reconfigures the injector 100 into an open configuration, as the drive pin 228 moves the ball valve element 220 off the valve seat 218, against the biasing force of the spring 206. The pin 208 limits the movement of the ball valve element 220 in an upstream direction.

Pushing the ball valve element 220 off the valve seat 218 permits fluid to flow through the valve opening 216, through the guide openings 231 in the guide 230 and into the central cavity 234 of the plunger 222 via the upstream openings 238 in the wall of the cylindrical portion 224 of the plunger 222.

Within the plunger 222, the fluid flows via a flow path extending along the longitudinal axis A of the injector 100, and out through the downstream opening 236. The downstream fluid pressure then opens the pressure-operated control ball valve 244, as the fluid flow pushes the ball valve element 250 off the valve seat 252 to open the valve opening 254, against the biasing force of the spring 246. The pin 248 limits the downstream movement of the ball valve element 250.

The ball valve element 250 being pushed away from the valve seat 252 allows fluid to flow towards the downstream end 210 of the injector 100 and out of the downstream end surface 214 via the outlet openings 212. Once the fluid has left the injector 100 proper, or “core” of the injector 100, it is funnelled into the cylindrical cavity 255 of the outlet insert 108 by the funnel 256, and exits the outlet insert 108 via the opening 112 of the fuel injector tip 110 to provide a desired spray pattern.

Once a desired amount of fuel has been injected (or rather, the injector has been in an open configuration for a desired amount of time), the electrically conductive coil 240 is de-energised, de-energising the magnetic portion 242. As a result, the biasing force of the spring 206 returns the ball valve element 220 to the valve seat 218, thus closing valve opening 216, and preventing any further fluid from flowing through the valve opening 216.

By pushing the ball valve element 220 in a downstream direction, the spring 206 also pushes the plunger 222 into the downstream direction.

As there is no more fluid flowing through the plunger 222, the biasing force of the spring 246 returns the ball valve element 250 to the valve seat 252, thus closing the valve opening 254.

While the disclosure refers to specific embodiments that have been illustrated and described in detail in the drawings and the foregoing description, such illustration and description are to be considered illustrative or exemplary and not restrictive. The disclosure is not limited to the disclosed embodiments. From reading the present disclosure, other modifications will be apparent to a person skilled in the art. It will be understood by those skilled in the art that various changes in form and detail may be made without departing from the subject matter set forth in the accompanying claims. Such modifications may involve other features, which are already known in the art and may be used instead of or in addition to features already described herein. In the claims, the word “comprising” does not exclude other elements or steps, and the indefinite article “a” or “an” does not exclude a plurality.

1-31. (canceled)

32. A fuel injector, comprising:
a housing comprising:
a fluid inlet at a first, upstream, longitudinal end of the housing;
a fluid outlet at a second, downstream, longitudinal end of the housing;
a valve opening disposed between the fluid inlet and the fluid outlet; and a valve seat surrounding the valve opening;
a ball valve element disposed within the housing;
a resilient element arranged to bias the ball valve element towards the valve seat to close the valve opening; and
a plunger configured to displace the ball valve element,
wherein the fuel injector is configurable between a closed configuration, in which the ball valve element is held in the valve seat by the resilient element, and an open configuration, in which the plunger displaces the ball valve element away from the valve seat to permit fluid flow from the fluid inlet to the fluid outlet along a flow path comprising a flow path section extending along a longitudinal axis of the housing.

33. A fuel injector according to claim 32, wherein the flow path section extends within the plunger.

34. A fuel injector according to claim 32, wherein the plunger comprises a fluid flow channel, the flow path section extending at least through the fluid flow channel.

35. A fuel injector according to claim 34, wherein the fluid flow channel of the plunger terminates at a downstream opening.

36. A fuel injector according to claim 35, wherein the downstream opening is arranged at or near a downstream end of the plunger.

37. A fuel injector according to claim 34, wherein the plunger comprises at least one upstream opening to permit fluid flow between a, or the, fluid flow channel of the plunger and the valve opening.

38. A fuel injector according to claim 32, wherein an upstream end of the plunger is configured to directly displace the ball valve element, optionally wherein the plunger comprises an integral drive pin aligned with the valve opening.

39. A fuel injector according to claim 32, wherein an upstream end of the plunger is configured to indirectly displace the ball valve element, optionally wherein a drive pin is coupled to the plunger and aligned with the valve opening.

40. A fuel injector according to claim 32, wherein, in the open configuration, at least a portion of a drive pin extends through the valve opening to push the ball valve element away from the valve seat.

41. A fuel injector according to claim 32, wherein the resilient element, ball valve element, valve seat, and valve opening are arranged adjacent the fluid inlet.

42. A fuel injector according to claim 32, further comprising a passive valve for preventing upstream fluid flow from the fluid outlet towards the fluid inlet;
optionally wherein the passive valve is arranged adjacent the fluid outlet.

43. A fuel injector according to claim 42, wherein the passive valve is a passive ball valve; optionally wherein the passive ball valve comprises a second resilient element, a second ball valve element, and a second valve seat, wherein the second resilient element is arranged to bias the second ball valve element towards the second valve seat to close the second valve opening.

44. A fuel injector according to claim 42, wherein the passive valve comprises a movable valve component, wherein the passive valve is configured so that:
movement of the movable valve component in a downstream direction opens the ball valve; and/or
the movable valve component is biased in an upstream direction to bias the passive valve into a closed configuration.

45. A fuel injector according to claim 32, wherein the fluid inlet comprises at least one inlet opening in the first, upstream, longitudinal end of the housing; optionally the fluid inlet comprises a plurality of inlet openings in the first, upstream, longitudinal end of the housing; and further optionally wherein the plurality of inlet openings is arranged in the first, upstream, longitudinal end of the housing annularly around the longitudinal axis of the housing.

46. A fuel injector according to claim 32, wherein the fluid outlet comprises at least one outlet opening in the second, downstream, longitudinal end of the housing; optionally the fluid outlet comprises a plurality of outlet openings in the second, downstream, longitudinal end of the housing; and further optionally wherein the plurality of outlet openings is arranged in the second, downstream, longitudinal end of the housing annularly around the longitudinal axis of the housing.

47. A fuel injector according to claim 32, further comprising:
a coil;
a first magnetic element coupled to the coil and arranged to surround at least a portion of the plunger;
and a second magnetic element forming at least part of the plunger,
such that energisation of the coil energises the first magnetic element and causes the plunger to move, actuating the fuel injector from the closed configuration to the open configuration;
optionally wherein the injector is configured so that the fluid flow path avoids the coil.

48. A fuel injector according to claim 32, wherein the housing, towards the second, downstream, longitudinal end, comprises a coupling configured to engage an outlet insert comprising a fuel injector tip.

49. A fuel injector according to claim 32, wherein a removable housing portion is coupled reversibly to a remainder of the housing; optionally wherein the removable housing portion comprises the valve seat, the valve opening, the ball valve element, and the resilient element.

50. A fuel injector according to claim 32, wherein a majority of the flow path extends along the longitudinal axis of the housing; optionally wherein at least 60%, or at least 65%, or at least 70%, or at least 75% of the flow path extend along the longitudinal axis of the housing.

51. A fuel injection system, the system comprising:
a source of pressurised fuel, and
a fuel injector according to claim 32, the fluid inlet of the fuel injector connected to the source of fuel;
optionally wherein the source of pressurised fuel is a source of hydrogen, a source of ammonia, a source of natural gas, a source of diesel, or a source of gasoline.
